(19) United States
(12) Patent Application Publication
(10) Pub. No.: US 2025/0229635 A1
(43) Pub. Date: Jul. 17, 2025

(54) MONITORING DEVICE FOR A CONVERTER OF A RAIL VEHICLE

(71) Applicant: Siemens Mobility GmbH, München (DE)

(72) Inventors: Markus Ackermann, Forchheim (DE); Bernd Laska, Herzogenaurach (DE); Volker Grabosch, Aurachtal (DE)

(21) Appl. No.: 18/852,610

(22) PCT Filed: Mar. 27, 2023
(86) PCT No.: PCT/EP2023/057859

§ 371 Date: Sep. 30, 2024

(30) Foreign Application Priority Data
Mar. 29, 2022 (DE) 10 2022 203 071.0

(51) Int. Cl. B60L 3/00; H02H 1/00; H02H 7/16

(52) U.S. Cl. CPC B60L 3/0046; H02H 1/0007; H02H 7/16; B60L 2200/26

(57) ABSTRACT

A monitoring device for a converter of a rail vehicle. The converter has a number of power capacitors and a number of power semiconductor switches which are arranged in a common, at least substantially closed housing. The monitoring device has an evaluation device and at least one gas sensor connected to the evaluation device for signal-transmitting purposes. The evaluation device is configured to interrupt a supply of energy to the number of power capacitors of the converter depending on a concentration, detected by way of the at least one gas sensor, of at least one combustible gaseous compound in the housing of the converter.

The invention relates to a monitoring facility for a converter of a rail vehicle, wherein the converter comprises at least a number of power capacitors and a number of power semiconductor switches, which are arranged in a common, at least substantially closed housing.

Electrically driven rail vehicles have one or more electric power trains, which drive one or more wheel sets of the rail vehicle by means of electric drive or traction motors. In such cases asynchronous or synchronous AC machines are usually used as the drive motors, which are fed by one or more converters. The converters are typically embodied as pulse-controlled inverters (PWR) in order to convert a DC voltage present on the input side into an output-side AC voltage of variable amplitude and frequency, with which stator windings of the drive motors are fed. The converter is fed in this case from a DC link circuit.

The DC link circuit for its part can be fed from various energy sources. In this way electrical energy is fed to the rail vehicle for example by a track-side energy supply network, which carries a DC or AC voltage and to which the power train of the rail vehicle is electrically connected via one or more pantographs. In Europe for example such supply networks carry AC voltages of 25 kV, 50 Hz, or 15 kV, 16.7 Hz, or DC voltages of 3 kV or 1.5 kV. For supply via an AC voltage supply network the power train usually additionally has a transformer, by means of which the high voltage of the supply network is transformed into a lower voltage, as well as one or more DC voltage converters fed by the transformer, usually what are known as four-quadrant converters (4QS), which convert the AC voltage into a DC voltage for the DC link circuit. For a supply via a DC voltage supply network on the other hand the electrical energy is either fed directly or via a DC voltage converter into the DC link circuit. As an alternative or in addition the supply can likewise be by means of an electrical energy source arranged on the rail vehicle. In this way for example a combustion engine can drive an AC generator that generates an AC voltage, which for its part is converted by means of a rectifier into a DC voltage for the DC link circuit. A drive or traction battery and also a fuel cell system can be provided in addition to this, which supply the DC link circuit via a DC converter for adapting the voltage level.

Arranged in the DC link circuit of the power train are one or more power capacitors, so-called link circuit capacitors, which serve as energy stores and also to reduce voltage fluctuations. Depending on the selected DC link circuit voltage of the voltage supplied by the electrical energy source, DC voltages of several hundred volts are present at the link circuit capacitors. In terms of construction the power capacitors, to reduce the required space, are usually arranged together with the power semiconductor switches of the converter in a common housing and are thus able to be assigned to the converter. In particular power capacitors in a distributed arrangement are employed in this case, wherein in each case one or more electrically parallel-switched power capacitors are assigned to a function of the converter, wherein the function of the converter can in particular be that of a known 4-quadrant converter (4QS), of a pulse-controlled inverter (PWR) or of a direct converter (DC/DC converter).

A further possible function of power capacitors in converters is in particular a filtering of an AC output voltage by pulse-controlled inverters to compensate for fluctuating power of an AC voltage supply network. An electrical connection that is as low-induction as possible between power semiconductor modules of the phases and the respective power capacitors is usually achieved by busbars.

The power capacitors are usually embodied as foil capacitors with a dielectric made of a plastic material such as polypropylene or polyester for example. As well as a fault caused by a short circuit, which can be detected by means of a suitable monitoring of the circuit, the occurrence of a power capacitor fault as a result of an ageing process of the metallization of the dielectric, consisting of aluminum or zinc for example, over the operating life of the power capacitor leads to increasing current heat losses, whereby an internal self-healing capability of the capacitor for internal fault locations of the metallization is restricted. This loss of self-healing capability can lead to the dielectric melting and to a pyrolysis, in which gaseous hydrocarbon compounds, so-called pyrolysis gases, occur. An excessive formation of such gases can lead to a rupturing of the capacitor housing, whereby an explosive atmosphere can form on contact with the ambient air in the converter housing.

As well as measures within the capacitor, such as a capability for self-healing, and also for example a strengthened capacitor housing, it is therefore recommended that additional protective measures be provided outside the capacitor in order to further reduce the risk of fires or even explosions, which can cause considerable damage to parts of the power train and also, depending on the arrangement of the converter housing, to the rail vehicle itself.

For monitoring in respect of the fault caused by the excessive formation of pyrolysis gases, the capacitor housing can for example be embodied in a specific way and provided with a monitoring apparatus, as disclosed by the international patent application WO 2017/028992 A. In this case a change in the volume of the capacitor housing due to an increased gas pressure serves to detect such a fault, in order to enable suitable measures to be initiated.

In power trains of older rail vehicles or of those that have already been in service for many years, such monitoring outside the capacitor is neither provided for nor are the power capacitors employed prepared for such monitoring, so that an upgrade is not possible in a simple manner. Replacing the power capacitors by those that are specifically prepared for monitoring should be avoided however, since this would result in high costs and in replacement of fully functional components of the power train, which are designed for the typical service life of a rail vehicle of up to thirty years.

The object of the invention is therefore to specify a monitoring facility for a converter, which in particular makes possible a simple and low-cost upgrade to monitoring external to the converter. This object is achieved by the respective features of the independent claims. Developments are specified in dependent claims in each case.

A first aspect of the invention relates to a generic monitoring facility for a converter of a rail vehicle, wherein the converter comprises at least a number of power capacitors and power semiconductor switches in each case, which are arranged in a common, at least substantially closed housing. Characteristically the monitoring facility comprises an evaluation facility and at least one gas sensor connected to this for signaling purposes, wherein the evaluation facility is embodied, depending on the concentration of at least one combustible gaseous compound in the housing of the converter detected by means of the at least one gas sensor, to bring about an interruption of a supply of energy to the number of power capacitors of the converter.

Advantageously the inventive monitoring facility in particular makes possible a simple upgrade of converters already in operation without requiring a replacement of power capacitors. In this case there is no direct monitoring of the power capacitors in the housing of the converter, as is disclosed in the international patent application WO 2017/028992 A1 mentioned in the introduction, but a monitoring of the atmosphere in the housing of the converter in respect of a concentration of one or more combustible gaseous compounds, in particular hydrocarbon compounds, as arise for example with a pyrolysis in the capacitor housing, by means of one or more suitable gas sensors. An evaluation facility connected to the one or more gas sensors for signaling purposes evaluates the detected concentration in this case and, depending on the evaluation, brings about an interruption of the supply of energy to the power capacitors of the converter or to the converter itself.

In the same way inventive monitoring facility is able to be employed in new converters or in an initial equipping of converters, in particular for a central monitoring of a plurality of power capacitors, whereby, by comparison with an individual monitoring, costs can advantageously be reduced.

Since a pyrolysis and thus the incidence of combustible gaseous compounds causes an input of energy into the faulty power capacitor, an interruption of the supply of energy represents a suitable measure for effective reduction of a further increase in the concentration of such combustible gaseous compounds in the housing of the converter and thereby the possible danger of a fire or of an explosion. Such an interruption of the supply of energy can preferably be undertaken, for a supply of the power train by means of a supply network, by tripping or opening a power switch, which is usually arranged for example in the form of a main switch between the pantograph and the power train, for example the transformer in the case of an AC voltage supply network or input filter in the case of a DC voltage supply network, and is able to be switched under load. As an alternative or in addition power switches provided in the power train, for example short circuiting devices in the form of thyristors or contactors, by means of which the DC link circuit or energy sources connected to said circuit are able to be short circuited, are likewise triggered as a measure for preventing a further input of energy into the faulty power capacitor. Preferably, in addition to an interruption of the supply of energy, the power capacitors should be discharged.

Advantageously the inventive monitoring by means of the one or more gas sensors should further likewise bring about the detection of an increased concentration of one more combustible gaseous compounds in the atmosphere of the converter housing that is not caused by a pyrolysis in one of the power capacitors but by other faulty electrical components in the housing of the converter. Combustible gaseous compounds arising from such components can be prevented or reduced in the same way by means of an interruption to the energy supply.

A converter, for which the inventive monitoring facility is advantageously able to be employed, as well as a number of power semiconductor switches, has a number of power capacitors. In an example of an embodiment of the converter as a drive or traction converter or specifically as a pulse-controlled inverter, as described in the introduction, suitable activation of the power semiconductor switches generates an output-side three-phase AC voltage of variable voltage level and frequency from an input-side DC voltage, with which the stator winding of one or more drive motors is fed. In this case the power semiconductor switches, in particular IGBTs (Insulated Gate Bipolar Transistors), are connected for example in accordance with a full bridge, in which two power semiconductor switches connected in series in each case are assigned to one of the phases of the three phases. Such a converter accordingly has at least six power semiconductor switches. A respective series circuit or a respective branch of the full bridge is assigned a power capacitor or a number of parallel-connected power capacitors in each case for example, so that in particular three or a multiple of three power capacitors are additionally arranged in the housing of the converter.

In the same way the inventive monitoring facility is for example also able to be employed in an auxiliary system converter of the rail vehicle, which provides an input-side DC voltage of the DC link circuit for example in a DC voltage of a different voltage level or an AC voltage of a specific frequency for auxiliary systems of the rail vehicle or of the power train. Such auxiliary systems especially comprise facilities for air conditioning and illumination of passenger spaces, controllers as well as information transmission and display systems, as well as pumps and ventilators in cooling systems for drive and traction components, respectively, of the rail vehicle. In particular the inventive monitoring facility can serve to monitor filter capacitors for the AC output voltages of an auxiliary system converter.

The housing of a converter is embodied in the usual way, in particular for protection of the components arranged therein from environmental influences, as a closed or substantially closed housing. In this case a substantially closed housing means that said housing is not completely or not hermetically closed off, a supply and venting of air from or into the environment of the housing occurs to such a small degree however that the concentration of combustible gaseous compounds increases due to a faulty power capacitor for example and can accordingly represent a danger.

In accordance with the invention a single gas sensor or a number of gas sensors is or are arranged in the housing of the converter, which is or are connected, for signaling purposes, to an evaluation facility. The gas sensor or sensors is or are preferably arranged at one location or distributed at different locations in the converter housing, at which a concentration of combustible gaseous compounds might have been increased due to a faulty power capacitor.

These types of suitable locations within the converter housing lie in particular in in the immediate vicinity of the power capacitors.

A gas sensor serves to detect the concentration of one or more combustible compounds, in particular of specific hydrocarbon compounds. Such gaseous compounds can, as described in the introduction, arise with a pyrolysis in the housing of a power capacitor, from which they escape for example via a pressure release valve or after a rupture of the capacitor housing into the environment or into the atmosphere inside the converter housing. The gas sensor in this case is preferably tuned to the detection of specific compounds such as arise in such a pyrolysis.

The inventive evaluation facility comprises one or more microprocessors for example, which evaluate the signals or information provided by the one or more gas sensors with regard to a concentration of combustible gaseous compounds and, depending on this evaluation, bring about an interruption of the supply of energy. With a number of gas sensors, the different information provided by said sensors can be evaluated by the evaluation facility individually or as a whole. In such cases the evaluation facility already brings about an interruption to the supply of energy for example if just one of the gas sensors detects a concentration to be potentially considered as dangerous. As an alternative an interruption can however also not be brought about by the evaluation facility until at least two of the plurality of gas sensors detect such a concentration or an average value formed of a number of detected concentrations indicates such a potentially dangerous concentration. By taking into account detected concentrations of a number of gas sensors, an interruption to the supply of energy that has effects on the operation of the rail vehicle, for example brought about by a malfunction of a gas sensor, is in particular advantageously prevented in this case. The evaluation facility should further take into account in the evaluation that the concentrations of combustible gaseous compounds that arise for a pyrolysis in a power capacitor, are in particular dependent on a temperature and also a pressure in the capacitor housing.

The supply of energy is preferably interrupted in a direct way by the evaluation facility. For this the monitoring facility or the evaluation facility are for example integrated or linked into a safety loop of the rail vehicle. Such a safety loop, such as can also be provided multiple times in a rail vehicle, serves in particular, on occurrence of a fault in a component of the power train for example, to open the main switch and/or another power switch and thus to disconnect the power train from the supply network, in order, by doing this, to prevent a further supply of electrical energy to the faulty component and thus a potential further destruction of this and possibly also of further components of the power train.

Where the rail vehicle is not being supplied with electrical energy by means of a supply network, another switch can correspondingly be opened by means of a safety loop, which disconnects the energy source from the power train.

As an alternative or in addition, an interruption of the supply of energy by the evaluation facility can also be brought about in an indirect way. For this the monitoring facility or the evaluation facility is connected for signaling purposes to a converter controller and/or a higher-ranking vehicle controller, which in their turn, by opening the main switch of a corresponding switch, can bring about an interruption to the supply of energy in each case.

A monitoring facility or the evaluation facility as well as the at least one gas sensor can preferably be supplied with electrical energy for its operation by corresponding further auxiliary systems of the rail vehicle. Thus the monitoring facility can correspondingly be supplied for example by the converter controller, wherein the energy supply can be supported by an on-board network battery, in order to be able to guarantee a function even on interruption of the supply of energy to the converter. Basically however the monitoring facility only needs to be supplied with energy during the operation of the converter or only for as long as this is being supplied with electrical energy, since a further generation of pyrolysis gases is also prevented with the interruption of the supply of energy.

In accordance with a first development of the monitoring facility the evaluation facility is further embodied to compare the detected concentration of the at least one gaseous compound with at least one predetermined threshold value and to bring about the interruption to the supply of energy if said value is exceeded.

The detected concentration is thus evaluated by a comparison with at least one predetermined threshold value, wherein this value or these values is or are held for the comparison for example by the evaluation facility in a memory facility of the evaluation facility connected for signaling purposes to the microprocessors. The respective threshold value in this case should preferably be selected or predetermined in such a way that the corresponding concentration of the gaseous compound in the atmosphere of the converter housing is not yet sufficient to represent an actual danger of a fire or of an explosion.

In the detection of a number of combustible compounds by the at least one gas sensor an individual threshold value is preferably predetermined for each compound. From corresponding comparisons of the detected concentrations with the individual threshold values the evaluation facility can obtain an overall picture, with the aid of which it can make a decision about the effect of an interruption to the supply of energy. As already mentioned above, the respective concentrations of such combustible compounds are dependent, with a pyrolysis in particular, on various factors, in particular a temperature and a pressure in the capacitor housing, so that, for each of the compounds considered, a comparison with various threshold values can be required.

As an alternative a capability of combustible compounds in the gas mixture to explode or catch fire or the capability of the atmosphere of the converter housing to explode can also be determined in summary by a suitably embodied gas sensor, wherein an evaluation is once again undertaken by means of a comparison with a predetermined threshold value.

In accordance with an alternate development of the monitoring facility to the previous development, the evaluation facility is further embodied to compare the detected concentration of the at least one gaseous compound with a first and with a second predetermined threshold value, wherein the second threshold value corresponds to a higher concentration of the at least one gaseous compound than the first threshold value, and to cause an alarm to be output when the first threshold value is exceeded and to bring about an interruption to the supply of energy when the second threshold value is exceeded.

Unlike in the previous development, in accordance with this alternate development, there is a multi-stage evaluation of the detected concentration of the gaseous compounds considered by the evaluation facility in each case. In this case, as a result of the comparison with the first predetermined threshold value, first of all the output of an alarm is first brought about by the evaluation facility when the detected concentration of the one gaseous compound or of the number of compounds in the gas mixture exceeds the first threshold value. As a result of the further comparison with the second predetermined threshold value the interruption to the energy supply is additionally brought about by the evaluation facility when the detected concentration also exceeds the second threshold value, which corresponds to a higher concentration. In the event of the second threshold value being exceeded, a further alarm distinct from the first alarm can be output where necessary by the evaluation facility in addition to the alarm brought about by exceeding the first threshold value. This further alarm should preferably be brought about in this case before the interruption, provided this also results in an interruption to the supply of the monitoring facility.

In accordance with a further development of the monitoring facility the evaluation facility is further embodied to be connected for signaling purposes to a control facility of the rail vehicle, wherein the control facility is embodied to bring about the output of at least the alarm to a person driving the rail vehicle via the human-machine interface and/or to bring about the interruption to the supply of energy to the number of power capacitors of the converter.

In addition to the output of the alarm, the control facility can also output further information provided by the monitoring facility, in particular measured values for a concentration of combustible or explosive compounds, a temperature in the converter housing and further detected measurement data via the human-machine interface. A suitable human-machine interface in this case is in particular a screen or display in the driver's cab of the rail vehicle.

According to this development the monitoring facility is connected for signaling purposes to a control level of the rail vehicle that, as an alternative or in addition, can bring about an output of an alarm and also an interruption to the supply of energy. Such a control facility can in particular be a converter controller, a drive controller ranked above this or a central train controller of the rail vehicle. Unlike a previously described direct opening of a power switch or main switch for example by the monitoring facility by means of a safety loop, there is instead a corresponding actuation in an indirect way via the higher-ranking control facility to which the monitoring facility is connected for signaling purposes. In particular when deciding whether an alarm signaled by the monitoring facility or a request for an interruption is actually to be made, the higher-ranking control facility can take into consideration further of the known states and parameters of the rail vehicle.

In accordance with a further development of the monitoring facility the evaluation facility is arranged in or on the housing of the converter, wherein in particular the evaluation facility and the at least one gas sensor are arranged in a common housing.

Basically the evaluation facility of the monitoring facility can be arranged at any given location in or on the housing of the converter to be monitored and of the at least one gas sensor in the housing and preferably in the vicinity of the power capacitors. For a simple upgrade of existing converters these components can however preferably be arranged in a common housing of the monitoring facility, which is attached at a central location within the converter housing. As an alternative such a common housing can also be attached to a location on the converter housing or to its outer side, wherein a direct fluid connection of the gas sensor to the atmosphere in the interior of the converter housing must be ensured, for example by a suitable, if necessary specifically created opening on the converter housing on which the gas sensor is arranged.

For the operation of the monitoring facility said facility is to be connected via suitably embodied electrical interfaces to the lines of an energy supply and also to signal lines. Where a number of gas sensors are provided in the converter housing, a gas sensor can be provided in the housing of the monitoring facility for example, the housing in this case can have, at least in the area of the gas sensor, an opening to the volume of gas in the housing of the converter, while one or more further gas sensors are connected via suitable interfaces and lines to the monitoring facility. This advantageously makes possible a flexible arrangement of gas sensors at the locations suitable for the detection within the converter housing, in particular when the power capacitors are arranged distributed to different locations within the converter housing.

In accordance with a further development of the monitoring facility the at least one gas sensor is embodied as a MEMS sensor or as an infrared gas sensor.

Known MEMS (Microelectromechanical-system) gas sensors, on account of their robustness and also of not needing to be calibrated, are especially suitable for use in converters of rail vehicles. Such a gas sensor can for example be embodied in such a way that it detects the combustibility of a gas mixture and can thus signal a danger of fire to the evaluation facility even without an additional comparison with one or more threshold values. As an alternative infrared gas sensors are likewise able to be employed, which in particular ensure a reliable detection of hydrocarbon compounds and thus provide a comparable monitoring quality to MEMS gas sensors.

In accordance with a further development of the monitoring facility the evaluation facility is further embodied to generate a history of the detected concentrations over time.

The generation of a history of the concentration detected by the at least one gas sensor in particular makes possible a temporal correlation between operating sequences of the converter and the detected increased concentrations of specific compounds, from which conclusions can be drawn about a possible case of a fault in a power capacitor. In order also to be able to provide such a history stored in a data memory of the evaluation facility even during a period of time in which the monitoring facility is not being supplied with electrical energy, the monitoring facility can in addition comprise a local energy source, for example a rechargeable battery.

In accordance with a further development of the monitoring facility, said facility further comprises at least one temperature sensor, which is connected to the evaluation facility for signaling purposes and by means of which a temperature in the housing of the converter and/or a temperature of a respective power capacitor or of its immediate environment is able to be detected.

As previously described, the temperature in the capacitor housing in particular has an influence on the formation of pyrolysis gases. The evaluation facility can thus advantageously take account of the detected temperature for example for the selection of threshold values for the comparison with detected concentrations of one or more different combustible compounds.

A second aspect of the invention relates to a converter for a rail vehicle, wherein the converter comprises at least one power capacitor and power semiconductor switches, which are arranged in a common, at least substantially closed housing.

The converter is characterized by a monitoring facility in accordance with the first aspect of the invention.

As described above, the converter can in particular be embodied as a traction system converter or as an auxiliary system power converter of a rail vehicle.

A third aspect of the invention relates to a method for monitoring a converter of a rail vehicle, wherein the converter comprises at least a number of power capacitors and power semiconductor switches in each case, which are arranged in a common, at least substantially closed housing. The method is characterized in that a monitoring facility is arranged in and/or on the housing of the converter, wherein the monitoring facility comprises an evaluation facility and at least one gas sensor connected to said facility for signaling purposes, that by the at least one gas sensor a concentration of at least one combustible gaseous compound is detected in the housing of the converter, and that an interruption to a supply of energy to the number of power capacitors of the converter is brought about by the evaluation facility depending on the detected concentration of the at least one combustible gaseous compound.

Finally, a fourth aspect of the invention relates to a use of a monitoring facility in accordance with the first aspect of the invention to upgrade monitoring of a number of power capacitors of a converter of a rail vehicle, in particular of a converter of an electrical power train of a rail vehicle.

The invention is explained below with the aid of exemplary embodiments. In the figures:

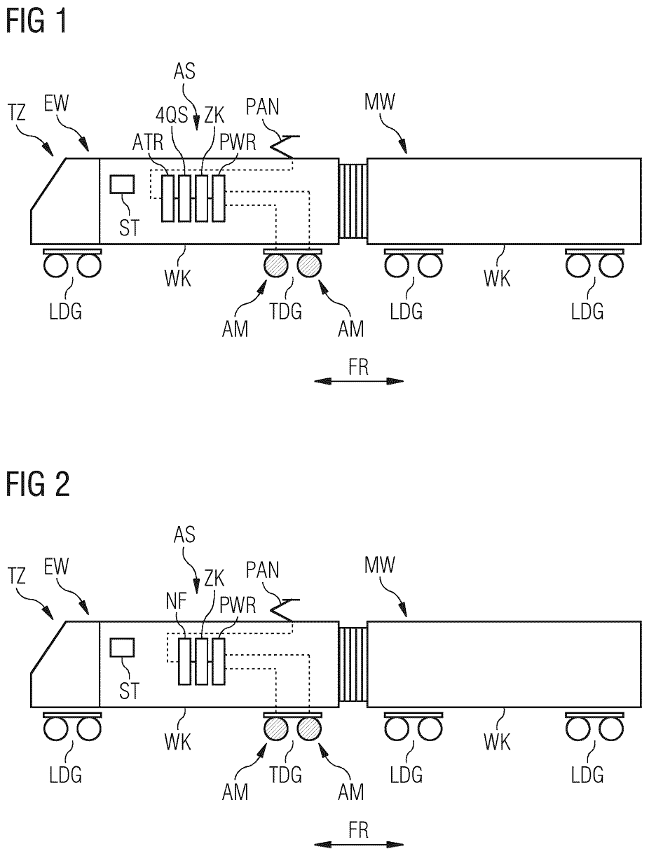

FIG. 1 shows a rail vehicle with an electrical power train for operation on an AC voltage supply network,

FIG. 2 shows a rail vehicle with an electrical power train for operation on a DC voltage supply network,

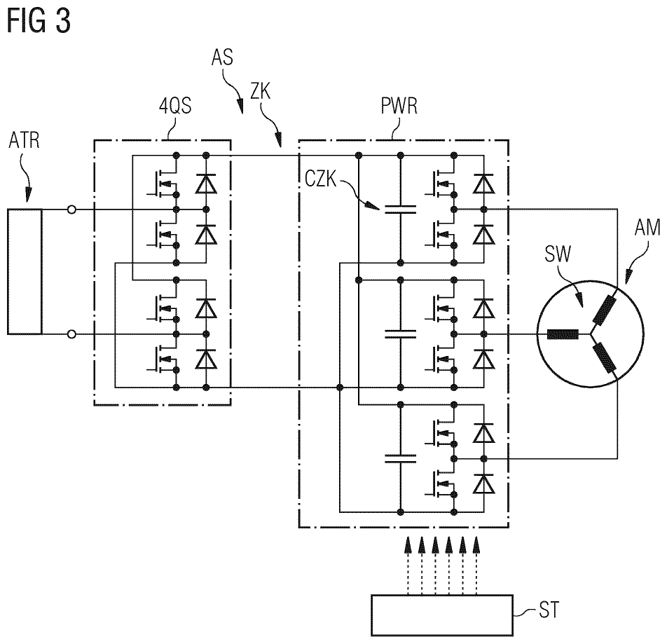

FIG. 3 shows an electrical power train for operation on an AC voltage supply network,

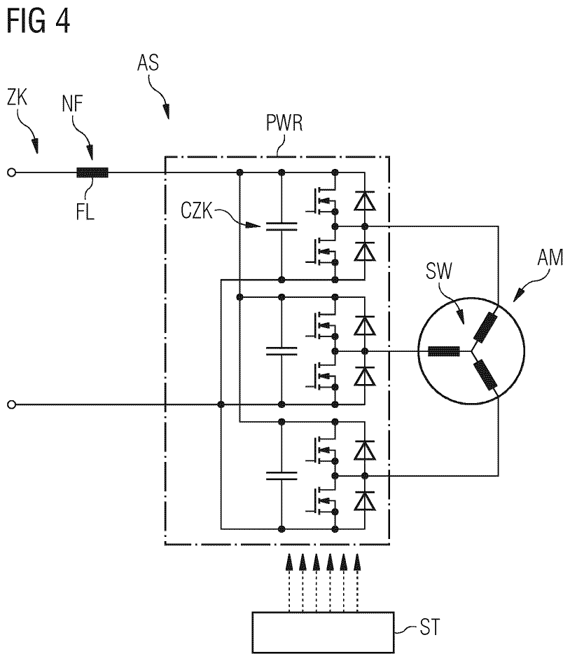

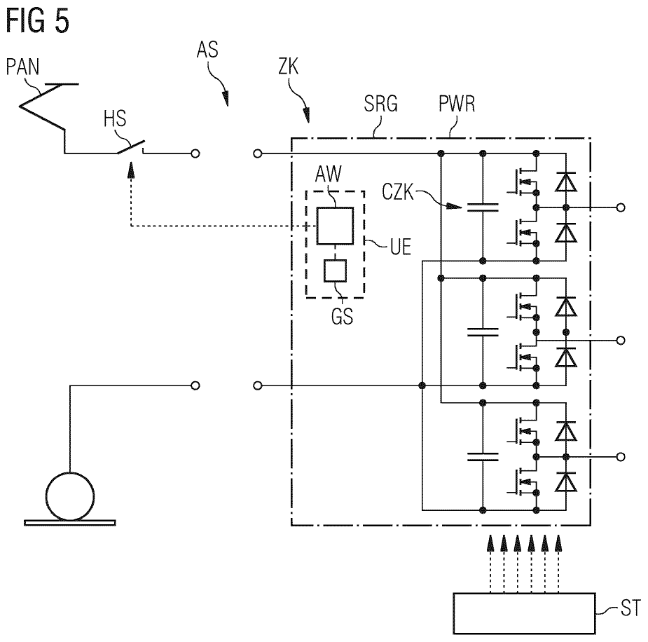

FIG. 4 shows an electrical power train for operation on a DC voltage supply network, and

FIG. 5 shows a first embodiment of the inventive monitoring facility in a power train,

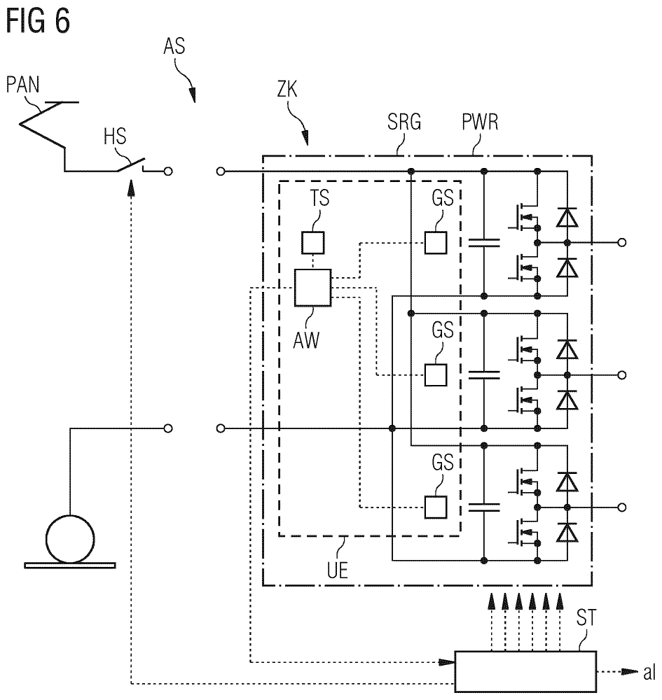

FIG. 6. shows a second embodiment of the inventive monitoring facility in a power train, and

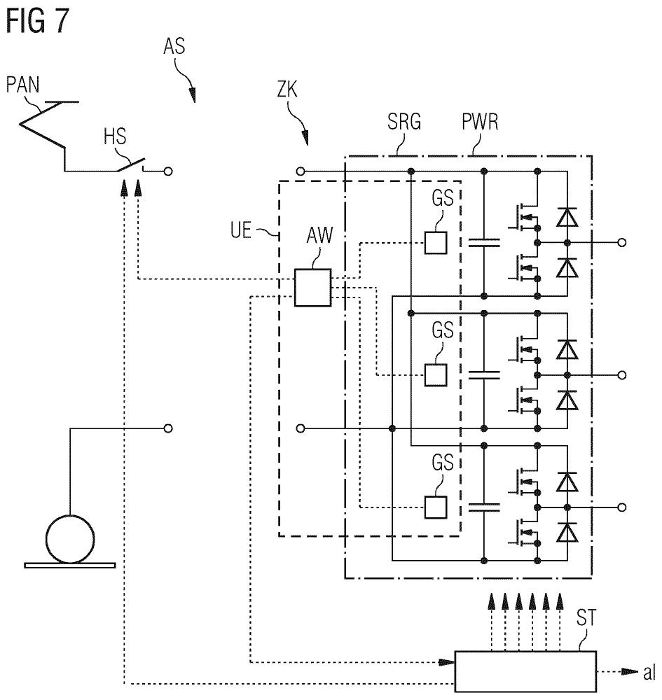

FIG. 7 shows a third embodiment of the inventive monitoring facility in a power train.

For reasons of clarity the same reference characters are used in the figures for the same components or for components that have the same or almost the same effect.

FIG. 1 shows a schematic of a rail vehicle TZ in a view from the side. The rail vehicle TZ is embodied by way of example as a multiple unit for passenger transport with a plurality of cars, wherein only an end car EW and also a middle car coupled to this are shown. Both cars have a respective car body WK, which is supported via bogies, in the form of a motor bogie TDG with drive motors AM arranged therein or carrying bogies LDG without traction motors, on rails of a track not shown in the figure. The rail vehicle TZ moves on the rails in the directions of travel FR predetermined by said rails.

Specified schematically in the end car EW are components of an electrical power train AS of a rail vehicle TZ operated on a AC voltage supply network. These components are usually arranged in specific areas within the car body WK, in the underfloor areas, in the roof area or distributed over a number of cars of the rail vehicle TZ. Further components of the power train AS, for example a traction battery, as well as auxiliary systems required for the operation of the components, are additionally provided, but not shown specifically in FIG. 1 however.

Via a pantograph PAN arranged for example in the roof area of the end car EW, the power train AS is able to be connected to an overhead line of the AC voltage supply network not shown, wherein the overhead line carries a single-phase AC current, for example. The AC current is fed to a network-side primary winding of a drive transformer ATR, in which the network-side voltage level of for example 15 kV, 16.7 Hz or 25 kV, 50 Hz is transformed to a lower level. A secondary winding of the drive transformer ATR is connected to a network-side converter 4QS, for example a four-quadrant converter, which rectifies the AC current.

The network-side converter 4QS feeds a DC link circuit ZK, which in its turn has a load-side converter PWR, for example a pulse-controlled inverter. Arranged in the DC link circuit ZK are one or more DC link circuit capacitors, which as energy stores especially serve to smooth the DC voltage. The load-side converter PWR generates from the DC voltage of the DC link circuit ZK a three-phase AC voltage of variable frequency and amplitude, with which the stator windings of for example two drive motors TM arranged in the motor bogie TDG of the end car EW are supplied. The function in particular of the network-side 4QS and of the load-side converter PWR is controlled in the known way by a control facility ST of the power train AS, wherein the respective control facilities for the converters can also be provided.

FIG. 2 shows schematically a rail vehicle TZ corresponding to the rail vehicle TZ of FIG. 1 with an alternate power train AS. In this example the pantograph PAN is able to be connected to an overhead line of a DC supply network, once again not shown in the figure. In the local transit field in particular a power rail is frequently routed in parallel to the track instead of an overhead line, with which the power train AS is able to be connected via one or more side current collectors, which are arranged for example in the area of the end of the car chassis or the bogie. The DC voltage of the supply network is suppled via an input filter or network filter NF to the DC link circuit ZK of the power train AS, wherein the network filter NF for example comprises a filter inductivity in the form of a choke as well as a capacitor, wherein the capacitor can likewise fulfil the function of a link circuit capacitor ZK of the power train AS.

FIG. 3 shows a schematic of the example of the power train AS of the rail vehicle TZ of FIG. 1, wherein not all components of the power train AS mentioned above are shown again. Thus for example only one secondary winding of the drive transformer ATR supplied by an AC voltage supply network and also only one drive motor AM is specified.

In the power train AS the secondary winding of the drive transformer AT is connected to the network-side converter 4QS. The network-side converter 4QS is embodied as a four-quadrant converter, which connects the AC voltage provided on the input side by the drive transformer ATR into a DC voltage and provides it on the output side. The conversion is undertaken here by means of power semiconductor switches or power transistors, which are realized for example on the basis of silicon semiconductors. Two power transistors in each case are connected electrically in series in the switch branch, of which the center connecting point is connected in each case to a respective input of the network-side converter 4QS. The outer connecting points of the switch branches on the other hand are connected to a respective output of the network-side converter 4QS.

Via the outputs the network-side converter 40S feeds a DC link circuit ZK, which in its turn is connected to inputs of the load-side converter PWR. The load-side converter PWR is embodied for example as a pulse-controlled inverter, which converts the DC voltage present on the input-side into an AC voltage of variable voltage level and frequency and provides it at outputs. The conversion is undertaken in its turn by means of power semiconductor switches or power transistors. By contrast with the network-side converter 4QS, the load-side converter PWR for the for example three phases of the stator winding SW of the drive motor AM, has three or a whole-number multiple of three parallel switch branches each with two power semiconductor switches connected in series. The drive motor AM fed by the load-side converter PWR is embodied for example as an asynchronous AC machine or as a permanent magnet-excited synchronous DC machine.

According to FIG. 3 a number of link circuit capacitors CZK connected electrically parallel are arranged in the DC link circuit ZK, wherein the three phases or switch branches of the load-side converter PWR are each assigned a DC link circuit capacitor CZK. As indicated by way of example by the dotted and dashed surrounding line, the DC link circuit capacitors CZK, together with the power semiconductor switches as well as the freewheeling diodes of the switch branches connected to them in an antiparallel manner are arranged in a common housing. The power semiconductor switches in the load-side converter PWR are controlled by a control facility ST, which is shown by six dashed arrows starting from the control facility ST. In the same way the control facility ST also, as described above, controls the power semiconductor switches of the network-side converter 4QS, which is not specifically shown in FIG. 3 however.

FIG. 4 shows a schematic example of the power train of the rail vehicle TZ of FIG. 2, wherein once more not all components of the drive system AS are shown again. The power train AS is embodied to be connected to a DC voltage supply network via a pantograph, wherein the DC voltage is supplied to the load-side converter PWR for example via an input filter or network filter NF consisting of a filter inductivity FL in the form of a choke and also a DC link circuit capacitor CZK. The filter inductivity FL, together with the DC link circuit capacitor CZK, forms a series harmonic circuit, which is tuned to the frequencies of fault currents to be filtered out. The load-side converter PWR for its part is embodied as a pulse-controlled inverter, which converts the DC voltage of the DC link circuit ZK present on the input side controlled by the control facility ST into a three-phase AC voltage of variable voltage level and frequency with which the three phases of the stator winding SW of the drive motor AM are fed.

FIG. 5 shows a schematic of a first embodiment and arrangement of a monitoring facility UE in a power train AS of a rail vehicle TZ. The power train AS shown corresponds in this case to that shown in FIGS. 1 and 3 or in FIGS. 2 and 4, wherein further components of the power train such as the transformer, the network-side converter or a network filter inductivity are not shown. The example of the power train AS is connected via a pantograph PAN and also a main switch HS to a track-side supply network, wherein the main switch HS serves in a known way to establish an electrical connection between the power train AS and the supply network or to disconnect it.

The monitoring facility UE is arranged in the closed or in the substantially closed housing of the load-side converter PWR. According to the example of FIG. 5 both an evaluation facility AW and also a gas sensor GS are arranged in a housing of the monitoring facility UE, wherein the gas sensor GS with the evaluation facility AW is both connected for signaling purposes and also is supplied by said facility with the electrical energy required for the function of the gas sensor GS. The housing of the monitoring facility UE has openings for example in order to ensure a direct fluid connection between the gas sensor GS and the atmosphere in the interior of the converter housing.

The evaluation facility AW in its turn, corresponding to further auxiliary systems of the power train AS, for example the control facility ST, is supplied with electrical energy. The evaluation facility AW is further connected to the main switch HS for signaling purposes, as is shown by the fine dashed line. This connection is implemented for example via an integration of the monitoring facility UE in a safety loop of the rail vehicle. Thus the evaluation facility AW is in a position to bring about an activation of the main switch HS in such a way that said switch disconnects the electrical connection between the power train AS and the supply network, whereby in particular the feeding of electrical energy into the load-side converter PWR is suppressed.

One object of the evaluation facility AW in this case is the evaluation of the concentrations of combustible compounds of pyrolysis gases detected in the housing by the gas sensor GS, for example a MEMS gas sensor, during the operation of the converter PWR. Based on the data or information relating to these concentrations provided by the gas sensor GS and where necessary a comparison with one or more threshold values predetermined and stored in the evaluation facility, the evaluation facility AW determines whether there is a potential danger of a fire in the converter housing and, where it has been established that this potential danger exists, activates the main switch HS or initiates such an activation via the safety loop.

FIG. 6 shows schematically a second embodiment and arrangement of a monitoring facility UE in a power train AS of a rail vehicle TZ, wherein the power train AS by way of example corresponds to that shown in FIG. 5. The evaluation facility AW is connected to a plurality of gas sensors GS via signaling and power supply lines, wherein the gas sensors GS are each arranged for example in the immediate vicinity of the power capacitors in the converter housing. The evaluation facility AW is further connected for signaling purposes to a temperature sensor TS, which can preferably be arranged at a central location within the converter housing or also together with the evaluation facility AW in a common housing. The temperature detected by the temperature sensor TS in the interior of the converter PWR can additionally be taken into account by the evaluation facility AW for determining a potential danger of a fire in the converter housing.

The evaluation facility AW according to the second embodiment is connected for signaling purposes to the control facility ST, which outputs an alarm al depending on signals of the evaluation facility AW received or, for example once again via a safety loop or a higher-ranking drive or vehicle controller, brings about an activation of the main switch HS. An alarm signal al can be output by the control facility ST in this case for example when the evaluation facility AW initially establishes an increase in the concentration of combustible compounds, but this does not yet lie in a critical range. Such an alarm signal al causes an alarm message to be output on a display in the driver's cab of the rail vehicle TZ for example. Because of this alarm message the person driving the rail vehicle can take or initiate further steps, for example firstly a visual check of the converter affected, or have such a check carried out during the next maintenance of the rail vehicle. The output of an alarm message al by the control facility ST is in the same way worthwhile on activation of the main switch HS, in order to notify the person driving the rail vehicle about the reason for the activation.

FIG. 7 finally shows a third embodiment and arrangement of a monitoring facility in a power train AS of a rail vehicle TZ, wherein the power train AS shown by way of example once more corresponds to that shown in FIG. 5 or FIG. 6. The evaluation facility AW is once again connected to a number of gas sensors GS arranged distributed in the converter housing. In this case however the evaluation facility AW is not itself arranged in the interior of the converter housing, but outside it for example in a separate housing. The evaluation facility AW is further embodied, both directly, in particular via a safety loop, and also indirectly via a control facility ST, to bring about an activation of the main switch HS and also the output of an alarm message.

Further embodiments of an inventive monitoring facility UE and also of its arrangement not shown in FIG. 5 to 7, including combinations of the embodiments shown, can likewise be realized.

List of reference characters

| | |
|---|---|
| 4QS | Network-side converter |
| Al | Alarm message |
| AM | Drive motor |
| AS | Drive train |
| ATR | Drive transformer |
| AW | Evaluation facility |
| CZK | DC link circuit capacitor |
| EW | End car |
| FL | Filter inductivity |
| FR | Direction of travel |
| GS | Gas sensor |
| HS | Main switch |
| LDG | Motor bogie |
| MW | Center car |
| NE | Input filter, network filter |
| PAN | Pantograph |
| PWR | Load-side converter |
| SRG | Converter housing |
| ST | Control facility |
| SW | Stator winding |
| TDG | Drive bogie |
| TS | Temperature sensor |
| TZ | Drive train |
| UE | Monitoring facility |
| WK | Car body |
| ZK | Link circuit, DC link circuit |

1-11. (canceled)

12. A monitoring facility for a converter of a rail vehicle, wherein the converter includes a number of power capacitors and a number of power semiconductor switches arranged in a common, at least substantially closed housing, the monitoring facility comprising:
an evaluation facility and at least one gas sensor connected to said evaluation facility for signaling purposes;
said gas sensor being configured to detect at least one combustible gaseous compound in the housing of the converter; and
said evaluation facility being configured, in dependence on a concentration of the at least one combustible gaseous compound in the housing of the converter, to bring about an interruption to a supply of energy to the number of power capacitors of the converter.

13. The monitoring facility according to claim 12, wherein said evaluation facility is further configured to compare the concentration of the at least one gaseous compound detected by said sensor with at least one predetermined threshold value and to bring about the interruption to the supply of energy if the threshold value is exceeded.

14. The monitoring facility according to claim 12, wherein said evaluation facility is further configured:
to compare the concentration of the at least one gaseous compound detected by said sensor with a first predetermined threshold value and with a second predetermined threshold value, the second threshold value corresponding to a higher concentration of the at least one gaseous compound than the first threshold value; and
when the first threshold value is exceeded, to bring about an output of an alarm; and
when the second threshold value is exceeded, to bring about the interruption to the supply of energy.

15. The monitoring facility according to claim 14, wherein said evaluation facility is configured to be connected to a control facility of the rail vehicle for signaling purposes, and wherein the control facility is configured to bring about at least one of the output of the alarm via a human-machine interface to a person operating the rail vehicle or the interruption of the supply of energy to the number of power capacitors of the converter.

16. The monitoring facility according to claim 12, wherein said evaluation facility is arranged in or on the housing of the converter.

17. The monitoring facility according to claim 16, wherein said evaluation facility and said at least one gas sensor are arranged in a common housing.

18. The monitoring facility according to claim 12, wherein said at least one gas sensor is a MEMS sensor or an infrared gas sensor.

19. The monitoring facility according to claim 12, wherein said evaluation facility is further configured to generate a history of the detected concentrations over time.

20. The monitoring facility according to claim 12, which further comprises at least one temperature sensor connected to said evaluation facility for signaling purposes, said at least one temperature sensor enabling at least one of a temperature in the housing of the converter, or a temperature of a respective power capacitor or of an immediate environment thereof to be detected.

21. A converter for a rail vehicle, the converter comprising:
at least one power capacitor and power semiconductor switch arranged in a common, at least substantially closed housing; and
a monitoring facility according to claim 12.

22. A method for monitoring a converter of a rail vehicle, the converter including a number of power capacitors and power semiconductor switches arranged in a common, at least substantially closed housing, the method comprising:
providing a monitoring facility in or on the housing of the converter, the monitoring facility including an evaluation facility and at least one gas sensor connected to the evaluation facility for signaling purposes;
detecting, by the at least one gas sensor, a concentration of at least one combustible gaseous compound in the housing of the converter; and
bringing about an interruption of a supply of energy to the number of power capacitors of the converter by the evaluation facility in dependence on the concentration of the at least one combustible gaseous compound detected by the at least one gas sensor.

23. A method for upgrading a monitoring of a converter of a rail vehicle, the converter having a number of power capacitors and power semiconductor switches arranged in a common, at least substantially closed housing, the method which comprises: retrofitting the converter with a monitoring facility according to claim 12 for monitoring the power capacitors of the converter.
